(19) United States
(12) Patent Application Publication
(10) Pub. No.: US 2015/0362434 A1
(43) Pub. Date: Dec. 17, 2015

(54) System and Method for Evaluating Biological Samples Remotely

(71) Applicant: MARKOPOLLO, INC., Rockville, MD (US)

(72) Inventors: Walter Finkelstein, Rockville, MD (US); Brent R. Berisford, Brookeville, MD (US)

(21) Appl. No.: 14/301,885

(22) Filed: Jun. 11, 2014

(51) Int. Cl. G01N 21/77; G06T 7/00

(52) U.S. Cl. CPC G01N 21/77; G06T 7/0014; G01N 2201/12; G06T 2207/10056; G06T 2207/30072

(57) ABSTRACT

Disclosed herein is a healthcare system and method for analyzing a biological sample having a data acquisition unit, a field unit for obtaining and storing visualized biomarkers; an optical lens adapter configured to adapt to an imaging device capable of taking images of the visualized biomarkers; a data analysis unit having an analyzing unit to receive and evaluate the image to determine the presence or absence of preset values that are above or below an arbitrarily set threshold level; and an output device providing a graphic or textual output according to the presence or absence of the preset values.

### TECHNICAL FIELD

The present application relates to the medical diagnostic or healthcare system and specifically to a system and method for evaluating biological samples from a remote location.

### BACKGROUND

In rural or underdeveloped areas, people often have to travel to cities to receive medical tests. Even if these rural/underdeveloped areas have small diagnostic centers or healthcare facilities, they do not have skilled personnel to conduct such testing on site and therefore, these centers or facilities have to ship biological samples to other locations, where such infrastructure is available. Hence, both these options are inefficient as they are expensive and excessively time consuming. Further, if the biological sample is being mailed in, there is the risk of the biological sample being contaminated or denatured before the tests can be conducted. Therefore, there exists a need for cost and time effective ways to evaluate biological samples to diagnose a disease.

### SUMMARY

In order to ameliorate the inefficiencies described above, the present application is directed towards a system and method for evaluating biological samples from a remote location. This way, the requisite information is sent to the patient is not required to travel, nor is she required to mail in biological samples.

The present application is aimed towards a healthcare system comprising a data acquisition system, the data acquisition system having a field unit for obtaining and storing visualized biomarkers and optionally, an optical lens adapter configured to adapt to an imaging device to take images of the biomarkers. Further, the healthcare system comprises an input device for receiving the images taken by the imaging device, an analyzing unit to evaluate the image to determine the presence or absence of preset values that are above or below an arbitrarily set threshold level; and an output device providing a graphic or textual output according to said presence or absence of said preset values.

Further, the present application is also directed towards a method for analyzing a biological sample containing one or more biomarkers, comprising, obtaining one or more visualized biomarkers in a biological sample, capturing an image of the one or more visualized biomarkers, applying present values to the image, at a remote location, to determine the presence or absence of the preset values that are above or below an arbitrarily set threshold level; and providing a graphic or textual output according to the presence or absence of the preset values.

Described herein is a system comprising: a data acquisition unit having a field unit for obtaining and storing visualized biomarkers; and an optional optical lens adapter configured to adapt to an imaging device capable of taking images of the visualized biomarkers; and a data analysis unit having an analyzing unit to receive and evaluate the image to determine the presence or absence of preset values that are above or below an arbitrarily set threshold level; and an output device providing a graphic or textual output according to the presence or absence of the preset values. In one embodiment, the field unit comprises: a set of detection reagents for visualizing one or more biomarkers; and a device for storing said visualized biomarkers. In another embodiment, the image collected by said imaging device is of said visualized biomarkers. In another embodiment, the image is observed through a diagnostic tool. In another embodiment, the optical lens adapter comprises: a base configured to hold the imaging device, the base being adjustable; an optional lens within at least one set of clamps; a mechanism for aligning a lens of said imaging device with an eye of said optical lens adapter; and one or more adjustable arms for further aligning said imaging device with the eye of said optical adapter. In another embodiment, the imaging device is selected from the group consisting of a camera integrated into a mobile phone, an optical camera, and a video camera. In another embodiment, the imaging device is capable of recording signals within visible spectrum. In another embodiment, the image is received by an input device. In another embodiment, the storage device is capable of receiving electronic data wirelessly and recording said electronic data in a computer readable format. In another embodiment, the analyzing device is capable of applying preset values to said image to determine the presence or absence of said preset values that are above or below an arbitrarily set threshold level. In another embodiment, the output device provides a graphic or textual output according to said presence or absence of said preset values. In another embodiment, the input device is a phone or a computerized device capable of sending images wirelessly to said storage device.

Described herein is a method for analyzing a biological sample containing one or more biomarkers, comprising: obtaining one or more visualized biomarkers in said biological sample from a field unit; capturing an image of said one or more visualized biomarkers with an imaging device; receiving the captured image of visualized biomarkers to an input device; analyzing the image by applying preset values to said image, at a remote location, to determine the presence or absence of said preset values that are above or below an arbitrarily set threshold level using the analytical unit; and providing a graphic or textual output according to said presence or absence of said preset values via the output device. In one embodiment, the method further comprises storing the captured image on a network. In another embodiment, the method further comprises retrieving the captured image from the network to the input device. In another embodiment, the visualized biomarkers are obtained by reacting said biological sample with a set of detection reagents present in the field unit. In another embodiment, the image is captured by: mounting an imaging device to a diagnostic tool, optionally with an optical lens adapter; and capturing said image with said imaging device as observed through said diagnostic tool. In another embodiment, the imaging device is mounted to said diagnostic tool using an optical lens adapter capable of holding the imaging device and aligning a lens of said imaging device with said diagnostic tool's field of vision. In another embodiment, the said captured image is transmitted wirelessly to and recorded on a storage device in a computer readable format at said remote location. In another embodiment, the captured image is wirelessly transmitted using a phone or a computerized device.

### BRIEF DESCRIPTION OF DRAWINGS

The novel features of the present subject matter are set forth with particularity in the appended claims. A better understanding of the features and advantages of the present subject matter will be obtained by reference to the following detailed description that sets forth illustrative embodiments, in which the principles of the subject matter are utilized, and the accompanying drawings of which:

FIG. 1 is a depiction of the health care system

FIG. 2 is a flowchart of the method for analyzing a biological sample remotely.

FIG. 3 is an illustration of an optical lens adapter that is used in conjunction with a diagnostic tool.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### DETAILED DESCRIPTION

The following description and examples illustrate embodiments of the present subject matter in detail. Those of skill in the art will recognize that there are numerous variations and modifications of this subject matter that are encompassed within its scope. Accordingly, the description of a preferred embodiment should not be deemed to limit the scope of the present subject matter All technical and scientific terms used herein have the same meanings as commonly understood by someone ordinarily skilled in the art to which this subject matter belongs. The following definitions are provided for the purpose of understanding the present subject matter and for constructing the appended patent claims.

The term “a” or “an” as used herein includes the singular and the plural, unless specifically stated otherwise. Therefore, the term “a,” “an” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of”

For purposes of better understanding the present teachings and in no way limiting the scope of the teachings, unless otherwise indicated, all numbers expressing quantities, percentages or proportions, and other numerical values used herein, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

“Field unit” as described herein, refers to reagents that can be used to detect the absence or presence of biomarkers that can be identified due to a visual change brought about by the regent when in contact with the biomarker. Assays are also a part of the field unit. The field unit is also equipped with a device for storing the biomarkers and its reactions with the detection reagents.

“Biomarkers” as described herein, refers to a biological indicator of a patient's medical condition. A biomarker could be either a DNA sequence, RNA sequence or a molecule that identifies the presence or absence of a medical condition. A biomarker could be used to examine functioning of biological processes, presence of pathogens in the body, or evaluate a response to a compound that has been administered.

“Visual biomarkers” as described herein, refers to biomarkers that depict a visually identifiable change when a patient's biological sample has been reacted with reagents, or assayed. Examples of a visual change are a change in color, intensity, or shape.

Other terms as used herein are meant to be defined by their well-known meaning in the art.

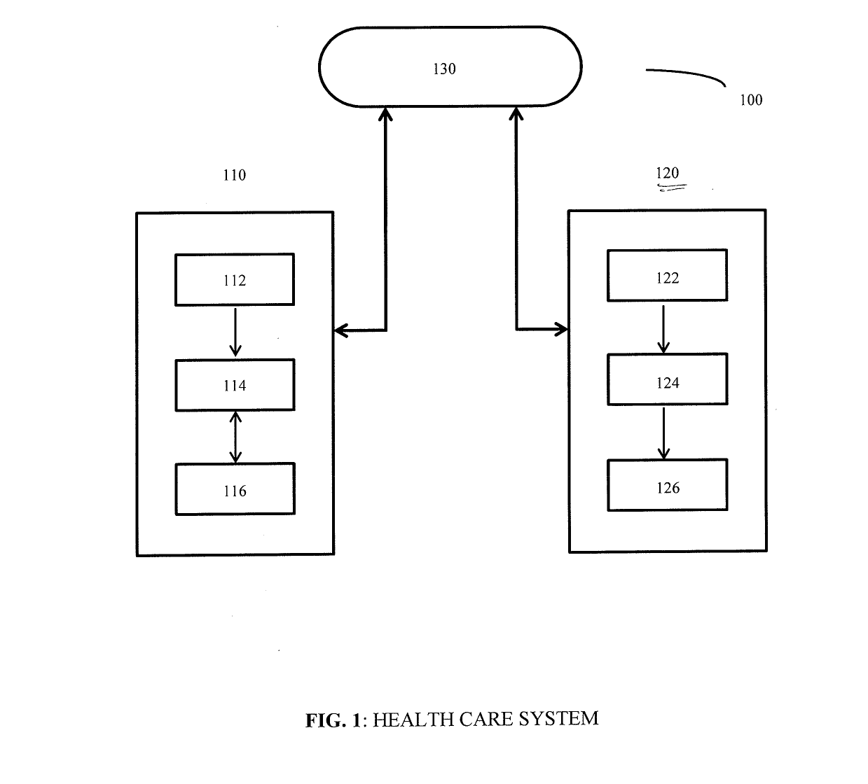

FIG. 1 of the present application depicts a healthcare system 100 that comprises a data acquisition unit 110 and a data analysis unit 120. The data acquisition unit 110 and the data analysis unit 120 may or may not be in the same location. The data acquisition unit 110 can be located where the patient is. The data analysis unit 120 can be located in a remote location, as compared to the data acquisition unit 110.

In one embodiment, the data acquisition unit 110 is connected to interact with a network 130. Information that is acquired by the data acquisition unit 110 can be stored in the network 130. In another embodiment, the data analysis unit 120 is connected to the network 130. The data analysis unit 120 is configured to the network 130 in such a way that it is able to send and receive data from the data analysis unit 120 to the network 130. In some embodiments, the data acquisition unit 110 and the data analysis unit 120 can be connected directly to each other without being connected to the network 130.

The data acquisition unit 110 of FIG. 1 includes a field unit 112, an optional optical lens adapter 114 and an imaging device 116. The field unit 112 has a set of detection reagents for visualizing one or more biomarkers, and a device for storing data with respect to the visual biomarkers.

In one embodiment, the visualized biomarkers are obtained on reacting the detection reagents with a biological sample from a patient. Examples of biological samples include, but are not limited to, cheek tissue, whole blood, dried blood spots, organ tissue, plasma, urine, feces, skin and hair. Various extraction techniques to obtain the biological samples include, but are not limited to, buccal swabs, venipuncture, fingerstick, biopsy, blood plasma fractionation, and hair analysis. These biological samples are a means of allowing access of the patient's DNA or RNA, which is then used to detect the presence or absence of visualized biomarkers after the sample has been reacted with diagnostic reagents.

In another embodiment, the field unit 112 has various reagents. There reagents include, but are not limited to, those as listed below.
R-1 Fixative Solution (ex tempore)
25 ml Citrate Solution (Cat No. 95-1)
65 ml acetone, and
8 ml 37% formaldehyde. Place in glass bottle and cap tightly
R-1a. Citrate Solution
Citric acid 18 mmol/L,
Sodium citrate 9 mmol/L,
Sodium chloride 12 mmol/L, and \
Surfactant, pH=3.6+0.1 (Cat. No. 91-5);
R-1b Acetone Reagent Grade.
R-1c Formaldehyde 37% (Catalog N. F. 1637); R-1d Sodium Chloride 12 mmol/L
R-2 Incubation Mixture for acid phosphatase processing. We suggest a modified simultaneous aZo dye method. Reagents for marker visualization are available from Sigma Chem. Co,
R-2a Naphthyl AS-BI Phosphoric Acid Solution (Cat. No. 387-1), or
R-2a^{r} Naphthol AS-BI phosphoric acid 12.5 mg/ml;
R-2b Fast Garnet GBC Base Solution (Cat. No. 387-2), or
R-2b^{r} Fast Garnet GBC base 7.0 mg/ml in 0.4 mol/L hydrochloric acid With stabilizer;
R-2c Sodium Nitrite Solution (Cat. No. 91-4), or
R-2c^{r} Sodium Nitrite 0.1 mol/L;
R-2d Acetate Solution (Catalog No. 386-3); or
R-2d^{r} Acetate buffer 2.5 mol/L, pH=5.2+0.1
R-3 Papanicolaou-modifed staining of cell morphology. We suggest absolute alcohol instead of denaturated alcohol used in Papanicolaou staining, and Light green instead of Fast green.
Reagents for counterstaining are available from Surgipath Medical Industries, Inc., Richmond, Ill.:
R-3a HematoXylin Solution Gill 3 (Cat. No. 01540);
R-3b Orange G (OG-6) Solution (Cat. No. 01660), or
R-3b^{r} Aqueous stock OG-6 solution 10%,
R-4d Ethyl alcohol 95%, 6,143,512
R-3b^{rr} Phosphotungstic acid.
R-3c Eosin Alcohol (EA-65) Solution (Cat No 01640), or
R-3c^{r1} Light Green in 95% alcohol,
R-3c^{r2} Bismarck brown in 95% alcohol,
R-3c^{r3} Eosin Yellowish and phosphotungstic acid); R-4d Ethyl alcohol 95%
R-3d Ammonium Water (Ex tempore)
R-3d^{r} 0.5 ml Ammonium Hydroxide Solution (Cat. No.)
R-5b Distilled water, 100 ml.
R-4 to R-6 Solvents and other reagents are available from different sources.
R-4a Ethyl Alcohol concentration 50%
R-4b Ethyl Alcohol concentration 70%
R-4c Ethyl Alcohol concentration 80%
R-4d Ethyl Alcohol concentration 95%
R-5a Phosphate Buffered Saline
R-5b Distilled Water
R-5c Tap Water.
R-6 Glycerol-Gelatin (Cat. No. GG-1) for mounting slides, where r is the stock solution.

Additionally, U.S. Pat. No. 6,143,512 To Markovic et al. is hereby incorporated by reference.

In some embodiments, the field unit 112 has assays or reagents, which are used in testing the biological sample to determine a visualized change. In other embodiments, assays that can be used include, but are not limited to, tissue microarrays, DNA microarrays, cellular microarrays, protein microarrays, antibody microarrays, phage display, and SAGE.

The biomarkers that are detected by the field unit 112 include, but are not limited to, biomarkers selected from the group consisting of bacteria, fungi, yeast, spores, virus, microbes, parasites, connective tissues, tissue components, exudates, pH, blood vessels, reduced nicotinamide adenine dinucleotide (NADH), flavin adenine dinucleotide (FAD), microorganisms, vascular endothelial growth factor (VEGF), endothelial growth factor (EGF), epithelial growth factor, epithelial cell membrane antigen (ECMA), hypoxia inducible factor (HIF-1), carbonic anhydrase IX (CAIX), laminin, fibrin, fibronectin, fibroblast growth factor, transforming growth factors (TGF), fibroblast activation protein (FAP), tissue inhibitors of metalloproteinases (TIMPs), nitric oxide synthase (NOS), inducible and endothelial NOS, lysosomes in cells, macrophages, neutrophils, lymphocytes, hepatocyte growth factor (HGF), anti-neuropeptides, neutral endopeptidase (NEP), granulocyte-macrophage colony stimulating factor (GM-CSF), neutrophil elastases, cathepsins, arginases, fibroblasts, endothelial cells and keratinocytes, keratinocyte growth factor (KGF), macrophage inflammatory protein-2 (MIP-2), macrophage inflammatory protein-2 (MIP-2), and macrophage chemoattractant protein-1 (MCP-1), polymorphonuclear neutrophils (PMN), macrophages, myofibroblasts, interleukin-1 (IL-1), tumour necrosis factor (TNF), nitric oxide (NO), c-myc, beta-catenin, endothelial progenitor cells (EPCs), matrix metalloproteinases (MMPs) and MMP inhibitors. In another embodiment, the biomarker detected by the field unit 112 is an enzyme. In another embodiment, the biomarker detected by the field unit 112 is an antibody. In another embodiment, the biomarker detected by the field unit 112 is a nucleic acid. In another embodiment, the biomarker detected by the field unit 112 is a polysaccharide. In another embodiment, the biomarker detected by the field unit 112 is a peptide.

The biomarkers detected by the field unit 112, are then stored in the field unit's 110 storing device (not shown in figure). In some embodiments, the storing devices used in storing the visualized biomarkers data can be a non-transitory computer readable medium. In other embodiments, the storing device can include, but are not limited to, primary storage mediums, such as computer memory, RAM, and ROM; secondary storage mediums such as CD, DVD, flash drives, floppy disks, magnetic tape, and punched cards. In other embodiments, memory can be stored onto a network, or in the cloud.

Images of the visualized biomarkers are taken using an imaging device 116. In a preferable embodiment, the images of the biomarkers can be taken using the imaging device 116 along with an optical lens adapter 114.

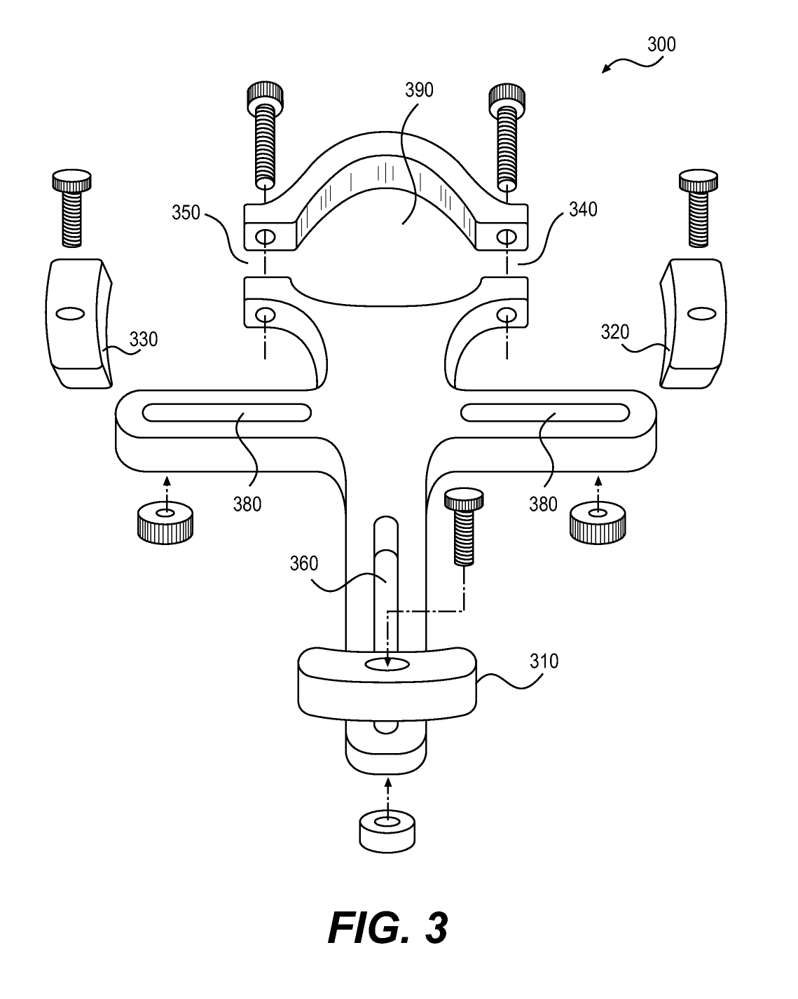

FIG. 3 of the present application depicts the optical lens adapter 300 that is used in conjunction with the imaging device and optionally a diagnostic tool. The optical lens adapter 300 is configured with a base 310, and at least one, or preferably two sides 320 and 330. The base 310 is used for holding the imaging device 116 in a fixed position. In one embodiment, the base 310 is attached to a guide 360 which helps in moving the base 310 to position the imaging device 116 so that the optical lens of the imaging device 116 coincides with the eye 390 of the optical lens adapter 300. The imaging device 116 and the optical lens adapter 300 are placed over the patient's biological sample, after the biological sample has been treated with reagents or assays from the field unit 112, and an image of the resultant visual biomarkers is taken. In one embodiment, the visualized biomarkers are seen through the diagnostic tool to further enhance the quality or resolution of the image. In another embodiment, the optical adapter 300 is used to align the lens of the imaging device 116 with the eye 390 of the optical adapter 300, such that lens of the imaging device 116 is within the diagnostic tool's field of vision.

Therefore, the base 310 of the optical lens adapter 300 can be moved up and down along the guide 360 so as to accommodate various sizes of imaging devices 116. In one embodiment, the optical lens adapter has at least one, and preferably two sides 320 and 330, which further help in positioning the imaging device 116 to take an image of the visualized biomarkers. In one embodiment, the sides 320 and 330 are adjustable as they can be moved side wards along guides 380. Such an arrangement helps in further positioning the imaging device 116 optimally.

In one embodiment, the optical lens adapter 300 is also configured with clamps 340 and 350 that can be attached to the diagnostic tool to firmly hold the optical lens adapter 300 in place. In an exemplary embodiment, the clamps 340 and 350 of the optical lens adapter 300 are clamped onto the diagnostic device, for example, a microscope. The clamps 340 and 350 are placed around the eye of the microscope such that when the imaging device 116 is placed on the optical lens adapter 300, the base 310 and the sides 320 and 330 can be adjusted along the guides 360 and 380 respectively, to accommodate the imaging device 116 in a way that the lens of the imaging device 116 aligns with the lens of the microscope so that an image of the visualized biomarker can be taken. In one embodiment, an optional lens can be placed between the clamps 340 and 350 to focus and improve the quality of the image of the visualized biomarkers.

In one embodiment, the imaging device 116 can be a camera which is integrated to a mobile phone, an optical lens camera or a fluorescence imaging device. The image that is obtained can be in the form of a still picture, a video, a 2-D image, a 3-D image, or a fluorescence spectroscopy. In one embodiment, the optical lens adapter 114 and imaging device 116 are placed over a microscope to observe and capture the visualized biomarkers.

In an exemplary embodiment, the diagnostic tool is a microscope. The microscope, (not shown in figures) is used to clearly visualize the biomarkers in the biological sample. After the biological sample is made to react with the reagents in the field unit 112, the biological sample and reagent mixture is placed on a slide to view under a microscope. In some embodiments, the optical lens adapter 114 and imaging device 116 is attached to the microscope, so that an image of the visualized biomarker can be taken in a magnified form.

The types of microscopes that can be used in the data acquisition system 110 include, but are not limited to, optical lens microscopes, electron microscopes, and scanning probes. Examples of microscopes that can be used are atomic force microscopy, ballistic electron emission microscopy, electrostatic force microscope, electrochemical scanning tunneling microscope, force modulation microscopy, kelvin probe force microscope, magnetic force microscopy, magnetic resonance force microscopy, near-field scanning optical microscopy (or SNOM, scanning near-field optical microscopy), piezo force microscopy, photon scanning tunneling microscopy, scanning atom probe, scanning capacitance microscopy, scanning electrochemical microscopy, scanning gate microscopy, scanning ion-conductance microscopy, spin polarized scanning tunneling microscopy, scanning thermal microscopy, scanning tunneling microscopy, scanning voltage microscopy, scanning Hall probe microscopy, and scanning SQUID microscope.

Examples of other diagnostic tools used in conjunction with the system of FIG. 1 include, but are not limited to, pipettes, micropipettes, centrifuges, slide glass, cover glass, tissue sampling spatula, Joplin jars, and other standard diagnostic laboratory tools.

The image from the data acquisition unit 110 is then sent to the network 130, where the image is stored. In addition to the image, other information such as a patient's name, details of the patient, and details about the sample can also be stored. This information can then be retrieved at any time, either by the patient or a user operating the data analysis unit 120.

The data analysis unit 120 comprises an input device 122, an analytical unit 124, and an output device 126. The input device 122 receives the image data that is stored in the network 130. In the alternative, the image data can be received by the input device directly from the data acquisition unit 110. The input device 122 processes the received image, and prepares it in a form that is acceptable to the analytical unit 124.

The analytical unit 124 receives information sent by the input device 122. In some embodiments, the input device 122 can be integrated into the analytical unit 124. In another embodiment, the analytical unit 124 is configured to store and apply a set of present values to the image received. The analytical unit 124, in one embodiment can be programmed to parameterize different values in the form of numbers, ranges of numbers, or a color spectrum. In one embodiment, the analytical unit 124 is programmed to compare the image received against the present values that are stored in the analytical unit 124. In another embodiment, the presence or absence of the present values that are above or below a set threshold level are analyzed by the analytical unit 124. After the analytical unit 124 has determined the presence or absence of the present values, a determination is made, and a result is sent to the output device 126.

The output device 126 receives the result sent from the analytical unit 124, and displays the result to an end user who is operating the data analysis unit 120 at the remote location. In one embodiment, the output device 126 displays the result on a screen in the form of a textual or graphical output. In another embodiment, the output device is automated and configured to directly contact the patient informing her of the test results via a telephone call, email or a text message.

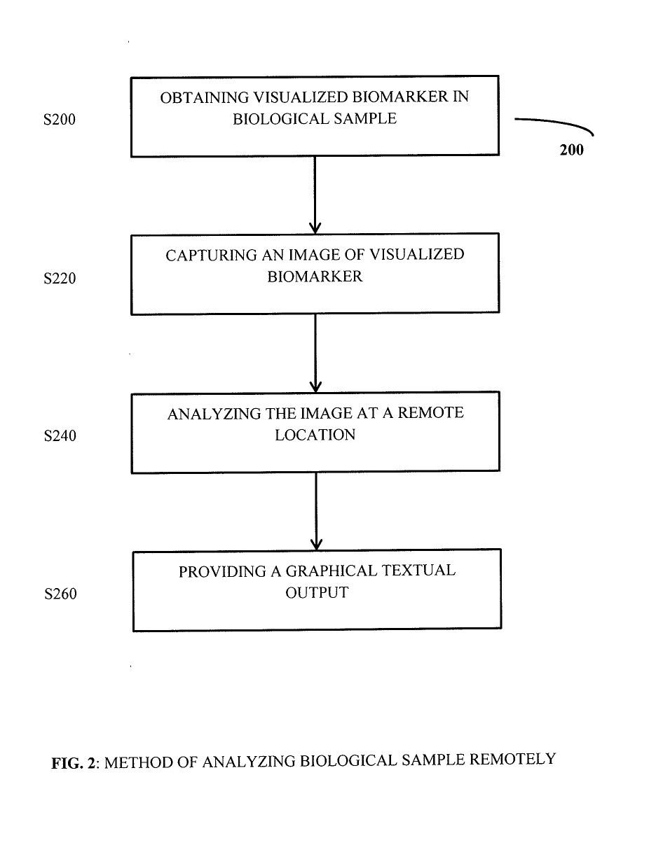

FIG. 2 of the present application depicts the method for analyzing a biological sample containing one or more visualized biomarkers comprising obtaining one or more visualized biomarkers in said biological sample from the field unit 112, capturing an image of said one or more visualized biomarkers using the optical lens adapter 114 optionally, and imaging device 116, receiving the captured image of visualized biomarkers to the input device, analyzing the image by applying preset values to said image, at a remote location, to determine the presence or absence of said preset values that are above or below an arbitrarily set threshold level using the analytical unit, and providing a graphic or textual output according to said presence or absence of said preset values via the output device.

As shown in step S200, visual biomarkers are obtained from a biological sample using the data acquisition unit 110. The biological sample is made to react with diagnostic agents of the field unit 112 after which the visualized biomarkers can be viewed with the help of the optical lens adapter 114 and an imaging device 116. In one embodiment, the biological sample, mixed with the reagent is placed under a diagnostic tool, such as a microscope.

In some embodiments, the optical lens adapter 114 optionally, and the imaging device 116 are used in capturing an image of the visualized biomarkers, as shown in step S220 of FIG. 2. In other embodiments, an image of the visualized biomarker is taken with the optical lens adapter 114 and the imaging device 116 in conjunction with the microscope.

In one embodiment, the information regarding the image of biomarkers is then sent to a remote location, where an analytical unit 124 analyzes the image, as shown in step S240 of FIG. 2. The information regarding the captured image can be sent to the data analysis unit 120 in a variety of ways. The image can either be stored one a network 130, and can be accessed by the diagnostic unit's 120 input device 122, or analytical unit 124. In other embodiments, the image can be sent to the data analysis unit wirelessly, for example, via email or text message.

Further, in other embodiments, the output device is used to provide either a graphical or a textual output of the determination made by the analytical unit, as shown in step S260 of FIG. 2. In some embodiments, the graphical or textual output is interpreted by an end user at the data analysis unit 120. In one embodiment, the end user is a medically licensed personnel to read and interpret the graphical or textual output. In another embodiment, the end user is a pathologist. In another embodiment, the end user is a scientist. In another embodiment, the graphical or textual output is interpreted by a computer program. In another embodiment, the computer program is capable of recognizing the graphical or textual features and assign numerical values to the features for the purpose of automatic interpretation of the features. In other embodiments, the data analysis unit 120 is automated, in that after interpreting the results of the image by the analytical unit 124, the data analysis unit 120 is configured to send an automated phone call, text message or email to the patient or user located at the data acquisition unit 100. In one embodiment, the graphical and textual output can also include the amount of money that is to be charged to the patient or insurance company for performing the testing.

With the information contained herein, various departures from precise descriptions of the present subject matter will be readily apparent to those skilled in the art to which the present subject matter pertains, without departing from the spirit and scope of the below claims. The present subject matter is not considered limited in scope to the procedures, properties, or components defined, since the preferred embodiments and other descriptions are intended only to be illustrative of particular aspects of the presently provided subject matter. Indeed, various modifications of the described modes for carrying out the present subject matter, which are obvious to those skilled in chemistry, or biochemistry, or related fields are intended to be within the scope of the following claims.

We claim:

1. A healthcare system comprising:
a data acquisition unit having
a field unit for obtaining and storing visualized biomarkers; and
an optional optical lens adapter configured to adapt to an imaging device capable of taking images of the visualized biomarkers; and
a data analysis unit having
an analyzing unit to receive and evaluate the image to determine the presence or absence of preset values that are above or below an arbitrarily set threshold level; and
an output device providing a graphic or textual output according to the presence or absence of the preset values.

2. The system of claim 1, wherein said field unit comprises:
a set of detection reagents for visualizing one or more biomarkers; and
a device for storing said visualized biomarkers.

3. The system of claim 2, wherein said image collected by said imaging device is of said visualized biomarkers.

4. The system of claim 2, wherein said image is observed through a diagnostic tool.

5. The system of claim 1, wherein said optical lens adapter comprises:
a base configured to hold the imaging device, the base being adjustable;
an optional lens within at least one set of clamps;
a mechanism for aligning a lens of said imaging device with an eye of said optical lens adapter; and
one or more adjustable arms for further aligning said imaging device with the eye of said optical adapter.

6. The system of claim 1, wherein said imaging device is selected from the group consisting of a camera integrated into a mobile phone, an optical camera, and a video camera.

7. The system of claim 1, wherein said imaging device is capable of recording signals within visible spectrum.

8. The system of claim 1, wherein the image is received by an input device.

9. The system of claim 1, wherein said storage device is capable of receiving electronic data wirelessly and recording said electronic data in a computer readable format.

10. The system of claim 4, wherein said analyzing device is capable of applying preset values to said image to determine the presence or absence of said preset values that are above or below an arbitrarily set threshold level.

11. The system of claim 11, wherein said output device provides a graphic or textual output according to said presence or absence of said preset values.

12. The system of claim 8, wherein said input device is a phone or a computerized device capable of sending images wirelessly to said storage device.

13. A method for analyzing a biological sample containing one or more biomarkers, comprising:
obtaining one or more visualized biomarkers in said biological sample from a field unit;
capturing an image of said one or more visualized biomarkers with an imaging device;
receiving the captured image of visualized biomarkers to an input device;
analyzing the image by applying preset values to said image, at a remote location, to determine the presence or absence of said preset values that are above or below an arbitrarily set threshold level using the analytical unit; and
providing a graphic or textual output according to said presence or absence of said preset values via the output device.

14. The method of claim 13, further comprising storing the captured image on a network.

15. The method of claim 13, further comprising retrieving the captured image from the network to the input device.

16. The method of claim 13, wherein said visualized biomarkers are obtained by reacting said biological sample with a set of detection reagents present in the field unit.

17. The method of claim 13, wherein said image is captured by:
mounting an imaging device to a diagnostic tool, optionally with an optical lens adapter; and
capturing said image with said imaging device as observed through said diagnostic tool.

18. The method of claim 17, wherein said imaging device is mounted to said diagnostic tool using an optical lens adapter capable of holding the imaging device and aligning a lens of said imaging device with said diagnostic tool's field of vision.

19. The method of claim 13, wherein said captured image is transmitted wirelessly to and recorded on a storage device in a computer readable format at said remote location.

20. The method of claim 19, wherein said captured image is wirelessly transmitted using a phone or a computerized device.
